(19) United States
(12) Patent Application Publication
(10) Pub. No.: US 2019/0171767 A1
(43) Pub. Date: Jun. 6, 2019

(54) Machine Learning and Automated Persistent Internet Domain Monitoring

(71) Applicant: PAYPAL, INC., San Jose, CA (US)

(72) Inventors: Raja Ashok Bolla, Austin, TX (US); Giselle Katrina Nevada, Hutto, TX (US); Kenneth Raymond Logan, La Vista, NE (US)

(21) Appl. No.: 15/830,940

(22) Filed: Dec. 4, 2017

(51) Int. Cl. G06F 17/30; G06N 99/00

(52) U.S. Cl. CPC G06F 17/30867; H04L 43/062; G06N 99/005

(57) ABSTRACT

Machine learning techniques are used to improve internet website and domain monitoring technology by classifying content using a trained algorithm. Based on crawling the web pages of a site, a machine learning classifier can be used to determine a composite content score for the website. Changes in the composite content score can be evaluated over time via multiple samplings of the website using the trained machine learning classifier. Additional weighting information can also be used as a factor in measuring website content change over time. Various change thresholds can be used with output of a machine learning classifier to determine content shifts over time.

### TECHNICAL FIELD

This disclosure relates to data processing using machine learning and artificial intelligence in relation to internet domain monitoring. More particularly, this disclosure relates to a particular machine learning architecture involving the analysis of internet domain content over periods of time.

### BACKGROUND

Machine learning and artificial intelligence techniques can be used to improve various aspects of decision making. In some instances, machine learning can be applied to allow a computer system to make an assessment that reduces the overall consumption of resources. At the same time, internet domain monitoring is often a resource intensive effort, particularly when monitoring larger numbers of domains.

### BRIEF DESCRIPTION OF THE DRAWINGS

FIG. 1 illustrates a block diagram of a system that includes web servers, a monitoring system with a machine learning classifier, a transaction system, and a network, according to some embodiments.

FIG. 2 illustrates a block diagram of web pages for an internet domain, according to some embodiments.

FIG. 3 illustrates a flow diagram is shown of a method that relates to internet domain content monitoring, according to some embodiments.

FIG. 4 is a diagram of a computer readable medium, according to some embodiments.

FIG. 5 is a block diagram of a system, according to some embodiments.

### DETAILED DESCRIPTION

As described herein, machine learning and artificial intelligence techniques can be leveraged to provide better internet domain content monitoring.

Internet websites may have a wide variety of content, and may sell many different goods and services. Sometimes, these goods and services are not legal, however. In various jurisdictions, sale of certain things may be regulated (e.g., prescription drugs, alcohol) or simply forbidden (e.g., automatic weapons, sex services).

An acceptable use policy (AUP) can be used by an electronic payment services provider to make sure that applicable laws and regulations are complied with. An AUP may also optionally forbid or regulate transactions involving certain types of content even where such transactions might otherwise be legal.

In order to enforce AUPs, internet websites are often monitored. This is often a time-consuming task performed by human evaluators. An evaluator may review a website's content to determine if the site is violating an AUP by selling forbidden goods or services, for example (or selling regulated goods or services without necessary regulatory compliance). Some AUP violations may be obvious, while some may be less easily detected.

Machine learning classifiers can be used to help expedite the categorization of different internet domains. Using training data (e.g. sites known to be in violation of AUPs, sites known to not be in violation of AUPs, and/or sites that have some degree of suspicion of AUP violation), a classifier can be trained so that it can assign scores to a website.

A website's content can be assessed, for example, relative to different AUP categories. A machine classifier might score a site as 12/100 for weapons violation, 2/100 for prescription drug (pharma) violations, 25/100 for illegal drug violations, etc. By assessing different web pages on a site, an overall composite score can be obtained as to whether the website is in violation of an AUP (and which sections of the AUP are being violated). Note, of course, that the 100 point scale used in this and other examples is arbitrary. Other scoring scales are possible, including categorization levels such as “very low”, “low”, “high”, etc.).

Websites may change over time, however. A “known good” website could in the future begin to violate an AUP even if it was previously in compliance. Instead of regularly monitoring websites by humans for changes, machine learning classifiers can be used to re-assess a degree of compliance with the AUP on a periodic basis. If scores for the website do not change significantly, it may be unnecessary for further human investigation. However, if a site experiences enough of a change, a human can be alerted to perform a closer assessment. In some cases, a large change in one category may necessitate an alert (e.g., the “weapons” category goes from 5/100 to 49/100). In other cases, smaller changes in several categories may precipitate an alert. This use of machine learning technology allows conservation of resources in ensuring AUP compliance.

This specification includes references to “one embodiment,” “some embodiments,” or “an embodiment.” The appearances of these phrases do not necessarily refer to the same embodiment. Particular features, structures, or characteristics may be combined in any suitable manner consistent with this disclosure.

“First,” “Second,” etc. As used herein, these terms are used as labels for nouns that they precede, and do not necessarily imply any type of ordering (e.g., spatial, temporal, logical, cardinal, etc.).

Various components may be described or claimed as “configured to” perform a task or tasks. In such contexts, “configured to” is used to connote structure by indicating that the components include structure (e.g., stored logic) that performs the task or tasks during operation. As such, the component can be said to be configured to perform the task even when the component is not currently operational (e.g., is not on). Reciting that a component is “configured to” perform one or more tasks is expressly intended not to invoke 35 U.S.C. § 112(f) for that component.

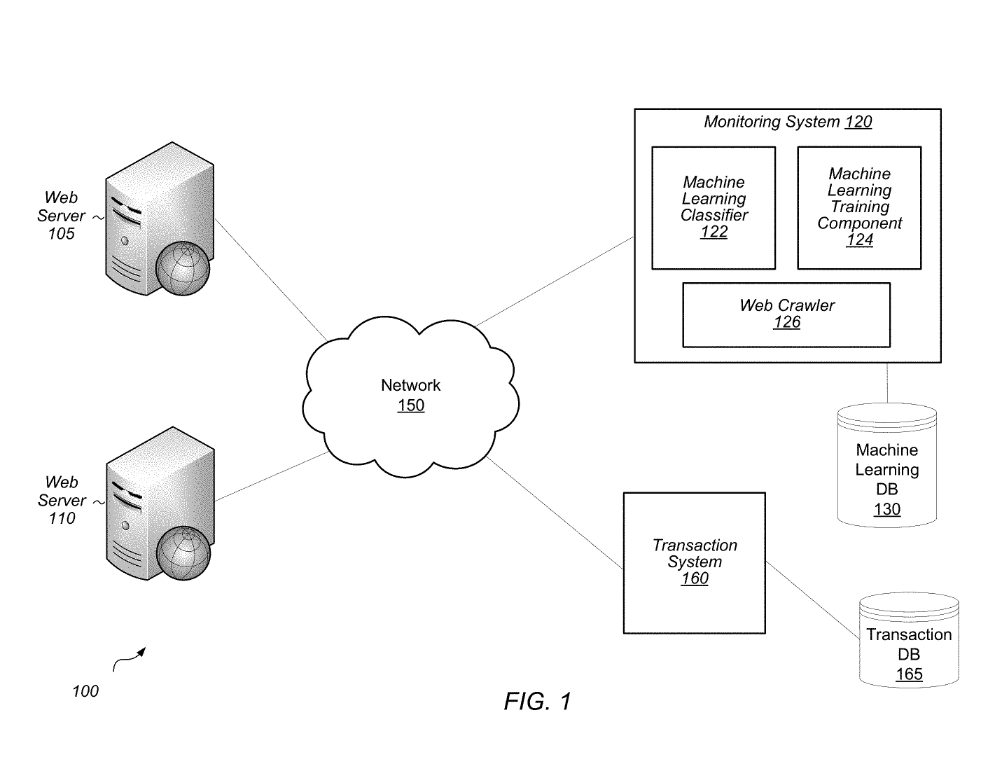

Turning to FIG. 1, a block diagram of a system 100 is shown. In this diagram, system 100 includes web servers 105 and 110, a monitoring system 120, a transaction system 160, and a network 150. Also depicted is transaction DB (database) 165 and machine learning DB (database) 130. Note that other permutations of this figure are contemplated (as with all figures). While certain connections are shown (e.g. data link connections) between different components, in various embodiments, additional connections and/or components may exist that are not depicted. Further, components may be combined with one other and/or separated into one or more systems.

Web servers 105 and 110 may be any computing device configured to provide web pages (e.g. in response to a HTTP request). Monitoring system 120 may comprise one or more computing devices each having a processor and a memory, as may transaction system 160. Network 150 may comprise all or a portion of the Internet.

In various embodiments, monitoring system 120 can take operations related to internet domain monitoring. This includes using machine learning techniques to determine content scores for different websites, and then monitoring changes in those scores over time. An information value (IV) can be used to measure the difference between a first content score signature and a second content score signature (e.g. a non-negative number serving as a proxy for the amount of change between two different content scans). In some cases entire internet domains may be monitored (e.g., all known accessible pages of a particular top-level domain). In other cases, monitoring can be performed for only portions of a top-level domain (e.g. a single domain might host multiple independent websites for different businesses that are separately monitored). In general, any techniques described herein relating to monitoring an internet domain can be applied to monitor a portion of a domain as well (e.g. limited subset of web pages for that domain).

Transaction system 160 may correspond to an electronic payment transaction service such as that provided by PayPal™. Transaction system 160 may have a variety of associated user accounts allowing users to make payments electronically and to receive payments electronically. A user account may have a variety of associated funding mechanisms (e.g. a linked bank account, a credit card, etc.) and may also maintain a currency balance in the electronic payment account. A number of possible different funding sources can be used to provide a source of funds (credit, checking, balance, etc.). User devices (smart phones, laptops, desktops, embedded systems, wearable devices, etc.) can be used to access electronic payment accounts such as those provided by PayPal™. In various embodiments, quantities other than currency may be exchanged via transaction system 160, including but not limited to stocks, commodities, gift cards, incentive points (e.g. from airlines or hotels), etc.

Transaction database (DB) 165 includes records related to various transactions taken by users of transaction system 160. These records can include any number of details, such as any information related to a transaction or to an action taken by a user on a web page or an application installed on a computing device (e.g., the PayPal app on a smartphone). Many or all of the records in transaction database 165 are transaction records including details of a user sending or receiving currency (or some other quantity, such as credit card award points, cryptocurrency, etc.).

In some cases, transaction database 165 may include details about which web page(s) a transaction has originated from. It may even include partial or complete web page flows of pages visited by a user leading up to the culmination of a transaction. Thus, if a user selects merchandise for purchase on page A and then proceeds to page B to purchase the merchandise, both these facts may be recorded in transaction database 165. (Of course, in various embodiments, organization may be organized differently and can be split across two or more databases).

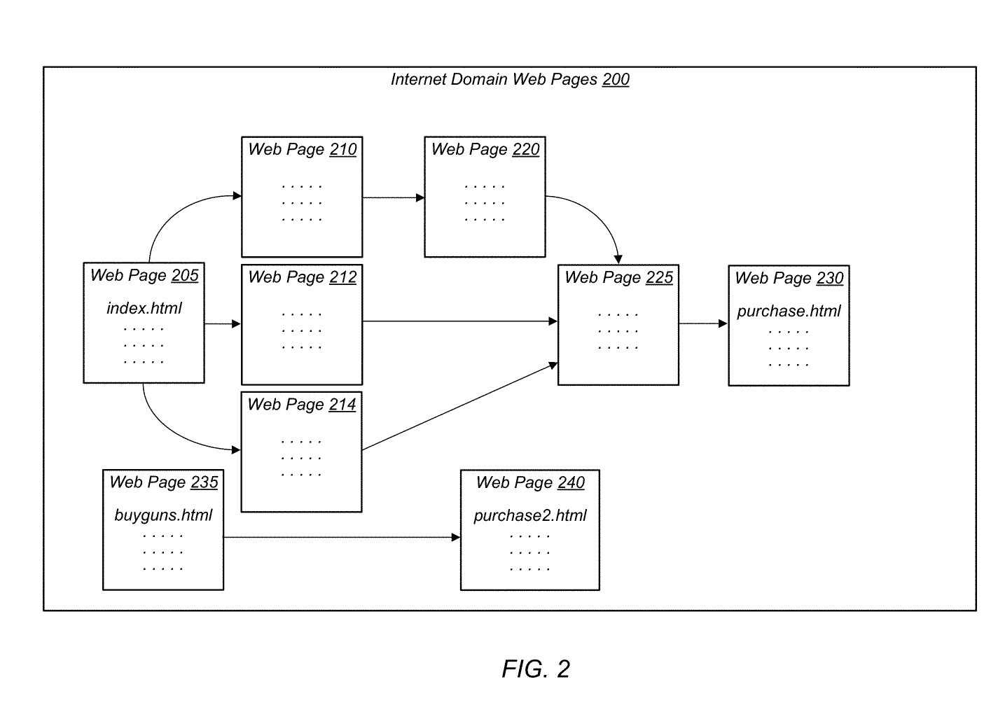

Turning to FIG. 2, a block diagram is shown of one embodiment of internet domain web pages 200. In this example, web pages 200 are a collection of various web pages belonging to a particular internet domain. This figure helps illustrate how an acceptable use policy (AUP) may be affected by different web pages on a site.

Web page 205 is a primary landing page (index.html) for an internet domain in the embodiment shown. This page includes links that allow navigation to three additional web pages 210, 212, and 214. These pages variously lead in turn to additional web pages 220 and 225. Web page 225 leads to web page 230 (purchase.html) which can be used to make purchases in various instances. Web page 230 may, for example, include code that causes an electronic transaction payment service (such that provided by PayPal™) to either approve or deny a purchase (by checking available credit, riskiness of transaction, etc.)

Web page 235 in this example is titled “buyguns.html” and leads to another purchase page, web page 240. In this case, web page 205 (index.html) does not lead to web page 235, which is separately accessible.

The AUP for the website is not violated by web page 205 (and all the other pages navigable to from that page). However, web page 235 contains content indicating that firearm purchases can be made from that page, in this example. Thus, web page 235 may violate an AUP imposed on the website by an electronic payment transaction service provider such as PayPal™ or any other such provider (e.g. a credit card network, a bank, or other financial entity). A machine-generated score for all the web pages of internet domain web pages 200 may therefore show that an AUP violation has occurred.

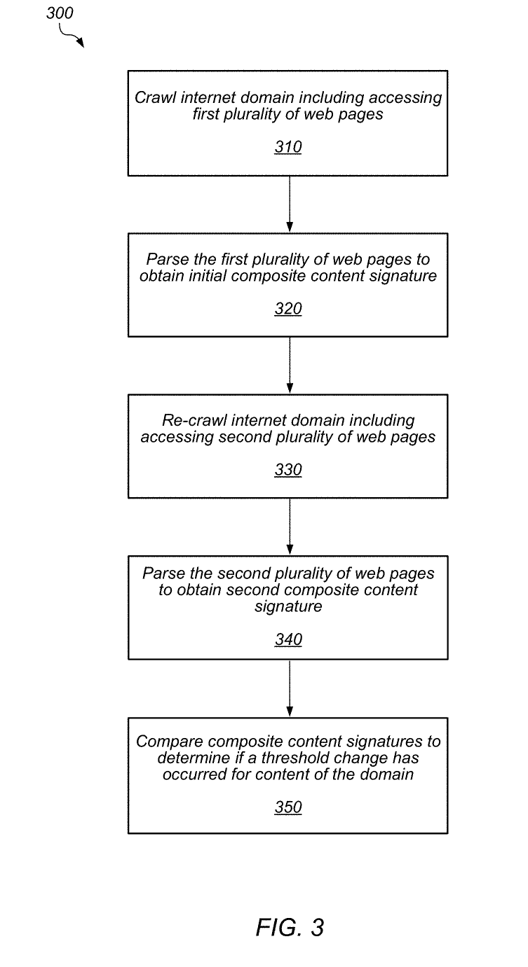

Turning now to FIG. 3, a flow diagram is shown illustrating a method 300 that relates to internet domain content monitoring, according to various embodiments.

Operations described relative to FIG. 3 may be performed, in various embodiments, by any suitable computer system and/or combination of computer systems, including monitoring system 120. For convenience and ease of explanation, however, operations described below will simply be discussed relative to monitoring system 120. Further, various elements of operations discussed below may be modified, omitted, and/or used in a different manner or different order than that indicated. Thus, in some embodiments, monitoring system 120 may perform one or more aspects described below, while another system might perform one or more other aspects.

In operation 310, monitoring system 120 crawls an internet domain, including accessing a first plurality of web pages, according to some embodiments. This operation can be performed by web crawler 126 (which can be implemented as one or more sets of computer program instructions stored on a suitable medium). Web crawler 126 may retrieve and/or scan the contents of various web pages on a domain and/or website. In some instances, a web page is downloaded for offline parsing, but may also be parsed and analyzed without permanently saving a copy of the web page.

In operation 320, monitoring system 120 parses a first plurality of web pages to obtain an initial composite content signature, according to some embodiments. Furthermore, content of each of the first plurality of web pages is assessed by a machine learning classifier relative to a plurality of particular categories, and each of the first plurality of web pages is assigned a weighting used to contribute to the initial composite content signature, in various embodiments.

Operation 320 thus relates to analyzing the content of the web pages on an internet domain to figure out if that domain is compliant with an acceptable use policy (AUP), in one embodiment. The content can be assessed to see if the internet domain might be in use to sell illegal firearms, illegal drugs, sex services, or other content regulated or forbidden by the AUP.

Parsing a web page can include a variety of operations. Various words in the web page can be read and analyzed. Distinctions may be made between content and non-visible source code in some instances by looking at source code of the web page to determine which portions are actual content and which are only code. Images on the web page may be analyzed using image identification software, in some cases. Thus, an image could be analyzed and determined to resemble a weapon, or as containing nudity, etc. Such image recognition may be a factor in assigning a category score to a web page. E.g., a web page with several images appearing to contain nudity may have a higher category score for “adult services” than a similar web page without such images.

A composite content signature for an internet domain can be determined based on content for the different web pages of the domain. Each web page can contribute to different category scores for the AUP. Using internet domain web pages 200 as an example, it may be the case that web pages 205, 210, 212, 214, 220, 225, and 230 contribute a cumulative total of 1 net point for the category of “illegal weapons”. Web pages 235 and 240 might contribute scores of 45 points and 5 net points, however, resulting in a score of 51/100 for the internet domain in the “illegal weapons” category. (Again, note that the 100 point scale is simply used here for ease of explanation; other scoring regimes are possible and contemplated).

Scores for each of the different AUP categories can therefore be determined as part of operation 320. A resulting composite content signature could then be represented as a series of scores for the categories. E.g., “0, 0, 25, 0, 50, 0, 3, 97” etc., indicating scores in different categories. In some cases, the composite content signature may therefore be represented as an N-dimensional vector (with N being the number of AUP categories assessed).

Machine learning classifier 122 can be used to assess content on various pages of an internet domain in some embodiments. This machine learning classifier can be trained using a set of training data comprising web pages that have been ranked by humans relative to the plurality of particular categories. The classifier can be trained on a page-by-page basis in some instances (e.g. trained to assess an individual page) or can also be trained on websites as a whole (e.g. trained on groups of multiple pages). A human being might view a particular page (or pages of a website) and reach the conclusion that the page is 100% certainty that the page is selling illegal weapons, but a 0% certainty that the page is selling illegal drugs. Another page (or website) might be rated as 20% certainty that the page is selling illegal weapons, but 80% certainty that the page is selling illegal drugs. (However, note that in some embodiments, only yes/no ratings from a human might be accepted, e.g., the human is expected to make a definitive judgement about the AUP category in question, rather than allowing for partial suspicion, e.g., a 50% ranking).

Machine learning training component 124 can be used to train machine learning classifier 122, which can be a logistic regression classifier, random forest (RF) classifier, a gradient boosting tree (GBT), or another type of classifier such as an artificial neural network (ANN), support vector machine (SVM), multinomial naïve Bayes, etc.

Thus, in one embodiment, training data comprising AUP category-scored web pages and/or websites are input into a GBT model having particular internal parameters (which may be constructed/determined based on the training data). Output of the GBT model having the particular internal parameters can then be repeatedly compared to known category scoring for the web pages/websites. The GBT model can then be altered based on the comparing to refine accuracy of the GBT model. For example a first decision tree can be calculated based on the known data, then a second decision tree can be calculated based on inaccuracies detected in the first decision tree. This process can be repeated, with different weighting potentially given to different trees, to produce an ensemble of trees with a refined level of accuracy significantly above what might be produced from only one or two particular trees.

Training an RF model can include generating a number of different decision trees each based on a subset of the training data. The decision trees can then be averaged together (or combined in another way, e.g., weighting trees with less errors higher) to come up with an ensemble classifier that can be used on unknown pages/websites. Features for the machine learning classifiers can include the appearance and/or frequency of certain words or phrases, the appearance and/or frequency of certain images or types of images, distance (closeness) of words and/or phrases to each other and/or to certain images or types of images, etc.

Accordingly, in other embodiments, an artificial neural network (ANN) model is trained to produce a machine learning classifier 122. Internal parameters of the ANN model (e.g., corresponding to mathematical functions operative on individual neurons of the ANN) are then varied. Output from the ANN model is then compared to known results, during the training process, to determine one or more best performing sets of internal parameters for the ANN model. Thus, many different internal parameter settings may be used for various neurons at different layers to see which settings most accurately predict whether a particular web page/website is likely to violate one or more AUP categories. In addition to the RF, GBT, and ANN models outlined above, other forms of machine learning may also be used to construct machine learning classifier 122. (Note that in various embodiments, method 300 may explicitly include training this classifier.)

Note that in some embodiments, multiple AUPs can even be assessed at the same time as part of method 300—there is no limitation to only assess one AUP at a single time. Thus, an AUP for one payments-related company (such as PayPal™) could be assessed alongside an AUP for another payments-related company (e.g., a credit card network, an acquirer bank, etc.). All operations discussed herein can be generalized to the multiple AUP case from the single AUP case in various embodiments. In cases with multiple AUPs, different machine learning classifiers may potentially be used. For example, a first AUP may not categorize gambling payments as restricted or illegal, while another AUP might. In this case, a separate machine learning classifier can be trained and used that assesses web pages/websites relative to gambling purchases. Indeed, it is possible to construct and train separate machine learning classifiers for each separate category of an AUP, which can provide flexibility. Thus, operations described above with respect to one machine learning classifier can be performed by multiple machine learning classifiers in various embodiments (and this may be true even in cases with a single AUP).

Note that the contribution of individual web pages to an overall score for a domain, in some cases, can be weighted according to different factors. In one embodiment, the “depth” of a web page from a root page may be used as an inverse weight. E.g., if the shortest path to a web page from a main page such as index.html is 4 clicks, the page may not be particularly important to the website. Conversely, content on a root page of a website such as index.html may be weighted the most heavily in some embodiments.

In a similar vein, web page traffic statistics can also be used to weight different web pages in terms of assigning content scores to a domain. For example, a page that receives 100,000 visitors a month may be weighted more heavily than a page that receives 5,000 visitors a month. Payment transaction traffic can also be used to weight different web pages. A page that generates 900 transactions a month can be weighted more heavily than a page that generates 100 transactions a month. All these weighting features can also simply be used as machine learning features by machine learning classifier 122 in various embodiments (e.g., a page's transaction information can be used as a feature to determine AUP category score).

Referring website traffic is another factor that can be used in determining an information value change for a website. It may be possible for a service provider to see what website(s) are a source of traffic for a website used for purchases. A shift in this pattern can indicate possible AUP violations as well. Transfer of domain ownership is yet another weighting factor that can be used, e.g., has WHOIS information for the domain changed since an initial crawling and a later crawling? (Note that WHOIS information, traffic information, and various other weightings discussed herein can be gathered in association with performing a crawling such as in operations 320 and 340.)

A shift in a transaction pattern can also be used by machine learning classifier 122 to determine a weighting. For example, an average purchase size changing from $22 to $390 is an indicator that different goods or services are being purchased by consumers. This can be a factor increasing the likelihood that the website has changed enough that it needs to be evaluated again by a human.

Pre-processing website data operations on website content can also be performed prior to machine learning operations. These operations may include extracting the entire text in a webpage and remove certain words (stop words, most frequently used words, etc.). The operations may then further include apply stemming, and calculating the count and term frequency/inverse document frequency (TF-IDF) for each keyword. Keywords and the associated count/TF-DIF can then be used as a feature matrix for various machine learning algorithms.

In operation 330, monitoring system 120 re-crawls the internet domain including accessing a second plurality of web pages, according to some embodiments. This operation may be performed after a period of time has passed since first the internet domain was first crawled, in order to determine what changes to page content may have occurred, for example.

Operation 330 may be performed in a similar fashion to operation 310, in various embodiments. Because the website in question may have changed, it may not have exactly the same pages as before. A web page may be added or deleted, or an existing page may have its content modified. The pages crawled in operation 330 may therefore not be exactly the same as those crawled in operation 310 (although in some cases, they will be).

In operation 340, monitoring system 120 parses the second plurality of web pages to obtain a second composite content signature, according to some embodiments. This operation may be performed similarly to various aspects of operation 320. Thus, content of pages can be accessed and machine learning classifier 122 can be used to help categorized web pages/websites. The resulting composite score may indicate whether a particular page and/or website is believed to violate particular AUP categories.

In operation 350, monitoring system 120 compares the initial composite content signature to the second composite content signature to determine if a threshold change has occurred for content of the internet domain, according to some embodiments. This operation can therefore include detecting whether a website that previously did not appear to violate an AUP now may appear to be in violation of the AUP.

Comparing two composite scores can include measuring a difference in one or more portions of the different scores (e.g. comparing a first category score to the same category score assessed at a later time). This value may be representative of an amount of change that has occurred for the website.

In some cases, a threshold level of change may occur with respect to a single AUP category. If the “illegal weapons” category goes from 0 to 40 on a 100 point scale between two different crawlings of a website, this may indicate a significant enough change that a human should closely examine the website. In other instances, a number of smaller changes may occur in multiple categories. E.g., several different categories may go up by a total of 3-10 points each. Cumulatively, this may represent enough change that human eyes on the website may again be warranted to ensure that the AUP is being complied with.

Thus, different thresholds may be used, such as score increases for a single AUP category and/or a cumulative score increase for a certain number of categories. Different thresholds for change may also be specified. E.g., one category may have a change threshold of 20 out of 100, while another category might have a change threshold of 15 out of 100. Thresholds can also be specified in percentage terms (e.g., a 50% rise might be significant even if the jump is only from 6 to 12 on a 100 point scale). Cumulative threshold increases may be specified for different categories as well. E.g., one policy could be to issue an alert if illegal weapons and sex services AUP categories increase by a net total of 20 points and/or either category sees a rise of 45% of more (minimum threshold 4 points on a 100 point scale). In some cases, absolute scores can also indicate that a threshold change has occurred. E.g., a score of 30/100 (or another threshold) could be specified as triggering human review. In this example, a website whose category score went up from 29 to 30 might generate an alert, even though the change that occurred was relatively small in percentage terms.

If a threshold level of change has occurred for content of an internet domain, one or more additional actions may be taken. Monitoring system 120 may flag an internet domain for human evaluation with respect to an AUP, for example. An email, SMS text message, or any other form of communication may be used to send an alert that a particular website is in need of human evaluation. In some cases, the alerts may have priorities attached to them. E.g., a large (definitive) jump in one category for a first website may earn a “high” priority, while a different website with small jumps in several categories might earn a “medium” priority for investigation.

Techniques described herein may also be applied to other environments besides website classification for AUP purposes. Fraud detection is one such case, and the present techniques can also be used for cases where website changes are monitored over time (e.g. copyright violation analysis).

In the case of fraud detection, certain types of change to merchant websites can indicate a higher likelihood of fraud. An indication that a merchant is selling new types of merchandise, for example, can indicate that the merchant may be engaging in speculative sales (selling items the merchant does not yet actually possess). In addition to AUP categories, for example, a website could simply be scored on many different possible categories of merchandise (all of which may be acceptable under an AUP).

Using techniques related above, a merchant website could be scored on a variety of categories with high scores for selling women's and children's clothing (e.g., high confidence the merchant is selling those types of goods). At a later time, a second automated content scan may reveal that the merchant is now selling jewelry. This can indicate a higher fraud risk, as a business that dramatically changes the type of merchandise it is selling may be more likely to receive fraud complaints from customers making purchases.

In other instances, a merchant might report to a financial services entity (such as a credit card network) that it sells goods and services in certain particular categories (such information might be used to assess fees, for compliance, etc.). An automated scan of the merchant's website, however, might reveal there is a significant probability (e.g. over a threshold amount such as 25%, 50%, 70%, or some other number), however, that the merchant is selling goods in a category not reported to the financial services entity. This may prompt an alert that a human being should assess the merchant's site to determine if the merchant is complying with applicable laws and/or contracts.

In yet other cases, automated website content assessment (e.g. through machine-learning related techniques discussed herein) can help detect fraud by doing pattern matching to known fraudulent websites. A database of known fraudulent websites can be maintained (e.g. by monitoring system 120 and/or transaction system 160), and those websites can be scanned for goods and services categories using an automated algorithm. Merchants committing fraud on their customers might, for example, have particular profiles (e.g. they might tend to sell watches, high end fashion clothing, and automobile parts). Different fraud profiles can be assembled based on known prior fraud instances. If an existing (not yet deemed fraudulent) website is revealed to have content category scores that are similar to a fraud profile, a human could again be alerted to take further investigative action to ensure that the merchant is legitimate. Scoring comparison could be done by assembling different merchant fraud profiles and seeing if another website fell within a certain threshold (percentage, absolute score, etc.) of one or more of the sales categories. Different thresholds can be used in different embodiments to establish the need for possible human investigation on a potentially fraudulent merchant website.

### Computer-Readable Medium

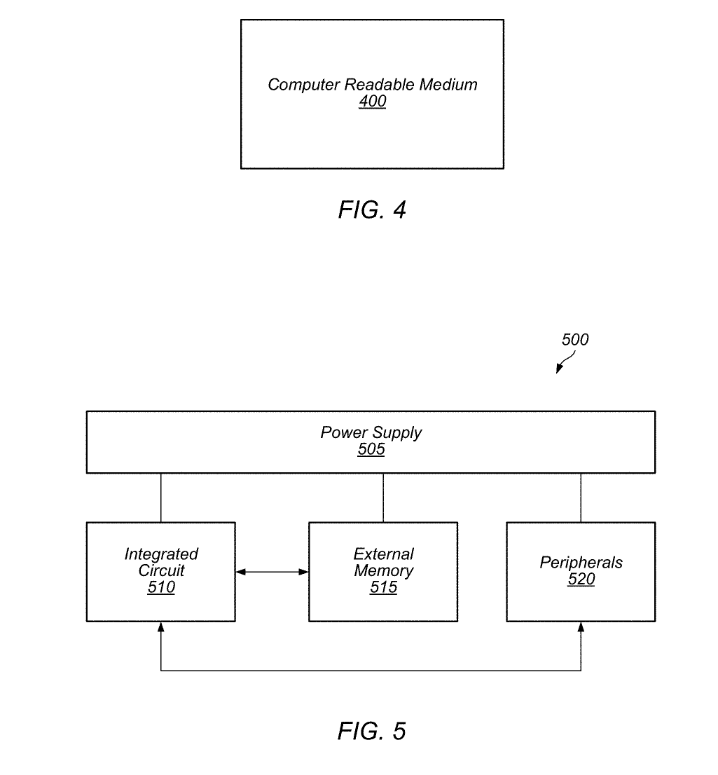

Turning to FIG. 4, a block diagram of one embodiment of a computer-readable medium 400 is shown. This computer-readable medium may store instructions corresponding to the operations of FIG. 3 and/or any techniques described herein. Thus, in one embodiment, instructions corresponding to monitoring system 120 may be stored on computer-readable medium 400.

Note that more generally, program instructions may be stored on a non-volatile medium such as a hard disk or FLASH drive, or may be stored in any other volatile or non-volatile memory medium or device as is well known, such as a ROM or RAM, or provided on any media capable of staring program code, such as a compact disk (CD) medium, DVD medium, holographic storage, networked storage, etc. Additionally, program code, or portions thereof, may be transmitted and downloaded from a software source, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing aspects of the present invention can be implemented in any programming language that can be executed on a server or server system such as, for example, in C, C+, HTML, Java, JavaScript, or any other scripting language, such as VBScript. Note that as used herein, the term “computer-readable medium” refers to a non-transitory computer readable medium.

### Computer System

In FIG. 5, one embodiment of a computer system 500 is illustrated. Various embodiments of this system may be monitoring system 120, transaction system 160, or any other computer system as discussed above and herein.

In the illustrated embodiment, system 500 includes at least one instance of an integrated circuit (processor) 510 coupled to an external memory 515. The external memory 515 may form a main memory subsystem in one embodiment. The integrated circuit 510 is coupled to one or more peripherals 520 and the external memory 515. A power supply 505 is also provided which supplies one or more supply voltages to the integrated circuit 510 as well as one or more supply voltages to the memory 515 and/or the peripherals 520. In some embodiments, more than one instance of the integrated circuit 510 may be included (and more than one external memory 515 may be included as well).

The memory 515 may be any type of memory, such as dynamic random access memory (DRAM), synchronous DRAM (SDRAM), double data rate (DDR, DDR2, DDR6, etc.) SDRAM (including mobile versions of the SDRAMs such as mDDR6, etc., and/or low power versions of the SDRAMs such as LPDDR2, etc.), RAMBUS DRAM (RDRAM), static RAM (SRAM), etc. One or more memory devices may be coupled onto a circuit board to form memory modules such as single inline memory modules (SIMMs), dual inline memory modules (DIMMs), etc. Alternatively, the devices may be mounted with an integrated circuit 510 in a chip-on-chip configuration, a package-on-package configuration, or a multi-chip module configuration.

The peripherals 520 may include any desired circuitry, depending on the type of system 500. For example, in one embodiment, the system 500 may be a mobile device (e.g. personal digital assistant (PDA), smart phone, etc.) and the peripherals 520 may include devices for various types of wireless communication, such as wifi, Bluetooth, cellular, global positioning system, etc. Peripherals 520 may include one or more network access cards. The peripherals 520 may also include additional storage, including RAM storage, solid state storage, or disk storage. The peripherals 520 may include user interface devices such as a display screen, including touch display screens or multitouch display screens, keyboard or other input devices, microphones, speakers, etc. In other embodiments, the system 500 may be any type of computing system (e.g. desktop personal computer, server, laptop, workstation, net top etc.). Peripherals 520 may thus include any networking or communication devices necessary to interface two computer systems.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed by various described embodiments. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A machine learning-based method for monitoring internet domain changes using a trained classifier, comprising:
crawling an internet domain, including accessing a first plurality of web pages;
parsing, by a computer system, the first plurality of web pages to obtain an initial composite content signature, wherein content of each of the first plurality of web pages is assessed by a machine learning classifier relative to a plurality of particular categories, and wherein each of the first plurality of web pages is assigned a weighting used to contribute to the initial composite content signature;
after a period of time has passed since first crawling the internet domain, re-crawling the internet domain including accessing a second plurality of web pages;
parsing the second plurality of web pages to obtain a second composite content signature; and
comparing the initial composite content signature to the second composite content signature to determine if a threshold change has occurred for content of the internet domain.

2. The method of claim 1, wherein the machine learning classifier is a logistic regression classifier.

3. The method of claim 1, wherein the machine learning classifier is trained using a set of training data comprising web pages that have been ranked by humans relative to the plurality of particular categories.

4. The method of claim 1, wherein the comparing includes determining if a score for one of the plurality of categories has changed by a threshold amount for a same web page between the crawling and the re-crawling.

5. The method of claim 1, further comprising:
weighting each of the first plurality of web pages according to a level of depth of the web pages from a starting location on the domain.

6. The method of claim 1, further comprising:
weighting each of the first plurality of web pages according to monitored traffic on those web pages.

7. The method of claim 1, further comprising:
weighting each of the first plurality of web pages according to electronic payment transaction purchases originated from individual ones of those web pages.

8. The method of claim 7, wherein a weighting for a particular one of the first plurality of web pages is based on a shift in a transaction pattern for purchases originating from the particular web page.

9. The method of claim 1, further comprising:
responsive to determining that the threshold change has occurred for content of the internet domain, flagging the internet domain for human evaluation with respect to an acceptable use policy (AUP) of an electronic service provider.

10. The method of claim 1, wherein the first plurality of web pages are the same as the second plurality of web pages.

11. A non-transitory computer-readable medium having stored thereon instructions that are executable by a computer system to cause the computer system to perform operations comprising:
accessing a first plurality of web pages obtained by crawling an internet domain;
parsing the first plurality of web pages to obtain an initial composite content signature, wherein content of each of the first plurality of web pages is assessed by a machine learning classifier relative to a plurality of particular categories, and wherein each of the first plurality of web pages is assigned a weighting used to contribute to the initial composite content signature;
after a period of time has passed since first crawling the internet domain, accessing a second plurality of web pages obtained by re-crawling the internet domain;
parsing the second plurality of web pages to obtain a second composite content signature; and
comparing the initial composite content signature to the second composite content signature to determine if a threshold change has occurred for content of the internet domain.

12. The non-transitory computer-readable medium of claim 11, wherein the machine learning classifier is based on gradient boosting trees.

13. The non-transitory computer-readable medium of claim 11, wherein the comparing includes determining if a score for one of the plurality of categories has changed by a particular percentage for the entire domain between the crawling and the re-crawling.

14. The non-transitory computer-readable medium of claim 11, wherein the comparing includes determining if a cumulative change in score for two or more of the plurality of categories has occurred between the crawling and the re-crawling.

15. The non-transitory computer-readable medium of claim 11, wherein the operations further comprise: using a transaction purchase pattern as a factor in determining if an acceptable use policy (AUP) may have been violated.

16. A system, comprising:
a processor; and
a non-transitory computer-readable medium having stored thereon instructions that are executable by the system to cause the system to perform operations comprising:
accessing a first plurality of web pages obtained by crawling an internet domain;
parsing the first plurality of web pages to obtain an initial composite content signature, wherein content of each of the first plurality of web pages is assessed by a machine learning classifier relative to a plurality of particular categories, and wherein each of the first plurality of web pages is assigned a weighting used to contribute to the initial composite content signature;
after a period of time has passed since first crawling the internet domain, accessing a second plurality of web pages obtained by re-crawling the internet domain;
parsing the second plurality of web pages to obtain a second composite content signature; and
comparing the initial composite content signature to the second composite content signature to determine if a threshold change has occurred for content of the internet domain.

17. The system of claim 16, wherein the operations further comprise:
weighting each of the first plurality of web pages according to monitored traffic on those web pages.

18. The system of claim 16, wherein the operations further comprise:
weighting each of the first plurality of web pages according to electronic payment transaction purchases originated from individual ones of those web pages.

19. The system of claim 18, wherein a weighting for a particular one of the first plurality of web pages is based on a shift in a transaction pattern for purchases originating from the particular web page.

20. The system of claim 1, further comprising:
responsive to determining that the threshold change has occurred for content of the internet domain, flagging the internet domain for human evaluation with respect to an acceptable use policy (AUP) of an electronic service provider.
